(19) United States
(12) Patent Application Publication
(10) Pub. No.: US 2013/0335003 A1
(43) Pub. Date: Dec. 19, 2013

(54) PERSONAL ELECTRONIC DEVICE CARRYING CASE HAVING AN INTEGRATED BATTERY-POWERED CHARGER

(71) Applicant: Remote Access Systems, Inc., Racine, WI (US)

(72) Inventors: David Buhler, Racine, WI (US); Michael Palazzola, Racine, WI (US)

(21) Appl. No.: 13/915,719

(22) Filed: Jun. 12, 2013

Related U.S. Application Data
(60) Provisional application No. 61/660,040, filed on Jun. 15, 2012.
(60) Provisional application No. 61/756,564, filed on Jan. 25, 2013.

(51) Int. Cl. H02J 7/00

(52) U.S. Cl. CPC H02J 7/0042
USPC 320/103

(57) ABSTRACT

A personal electronic device carrying case is described. The carrying case includes a securing mechanism for retaining the personal electronic device in place, a charging unit, and a physical keyboard. The charging unit includes a charger, a battery, and a connecting cable. The charging unit and physical keyboard may be connected such that a single connecting cable is used to connect the charger and keyboard to the personal electronic device. This carrying case provides advantages in protecting the personal electronic device while providing a means to charge the personal electronic device in the event that the personal electronic device's battery runs low. This will be especially appealing when a wall receptacle is unavailable to recharge the personal electronic device battery, for instance when a user is on an extended plane flight.

### CROSS-REFERENCE TO RELATED APPLICATIONS

This application claims priority under 35 U.S.C. §119 based on U.S. Provisional Patent Application No. 61/660,040, which was filed on Jun. 15, 2012 and U.S. Provisional Patent Application No. 61/756,564, which was filed on Jan. 25, 2013, the subject matter of each of which is incorporated by reference in its entirety.

### BACKGROUND OF THE INVENTION

1. Field of the Invention

The present invention relates in general to the field of carrying cases for personal electronic devices. More particularly, the present invention relates to a protective carrying case for a personal electronic device that includes a charging unit and a physical keyboard via a connection cable, and may include additional features such as an easel stand.

2. Discussion of the Related Art

Personal electronic devices have gained widespread and ever-growing use by consumers. These devices include a number of portable devices that are used for computing, communicating, and/or viewing. These devices include, for example, laptop computers, computer tablets, and smart phones. They typically can be powered either by being plugged into an electrical outlet via an adapter, or by internal rechargeable batteries.

As is known to those skilled in the art, personal electronic devices offer many technological benefits, but these devices also suffer from some drawbacks, especially for those traveling. For instance, a recurring problem is that the batteries of such devices often have insufficient battery power to last long periods of time without recharging. Unfortunately, a power outlet is not always readily available if, for example, the user is on a lengthy flight. Many users seek to avoid this problem by carrying a reserve battery on trips and replacing the device's battery with the reserve battery when the device's battery runs low on power. However, this changeover requires relatively delicate operations that may be difficult to perform in a cramped space such as an airplane seat. Additionally, an increasing number of these devices have batteries that cannot be removed without partially disassembling the devices using tools, so carrying a reserve battery may not be a viable option. Needless to say, it is desirable to find a technique for effectively prolonging the battery life of personal electronic devices.

In addition, although some of these devices offer touch screen keyboards or miniature thumb operated keyboards that are sufficient for short, abbreviated use, another difficulty that many users encounter involves using these keyboards for extensive periods of time. Therefore, there is benefit in having a physical keyboard that could be used in connection with a personal electronic device. Although there are other physical keyboard accessory options, some of the personal electronic devices offer accessory keyboards that can only connect to the device through a wireless connection. Wireless connections have the advantage of lacking the need for cables and connectors but suffer from several drawbacks. For example, they usually cannot be used on airplanes and other settings in which wireless transmissions are prohibited by law or regulation and/or could interfere with other systems or devices. Wireless connections are also relatively costly. In addition, wireless devices typically are capable of permitting communication only in one direction at a time. This drawback can severely limit the range of uses of a particular device. For example, a user of a wireless keyboard connection cannot listen to music over the same connection while operating the keyboard.

A further difficulty occurs when using some personal electronic devices on a flat surface. Because most of these devices cannot stand alone, personal electronic devices must rest on a horizontal surface during use. This requires the user to bend over and look down in order to view the screen. Especially when typing messages on such a device, this task is uncomfortable after a short period of time.

Another common problem with personal electronic devices is that they are relatively fragile, leading many users to employ protective cases. However, many existing protective cases hinder unobstructed access to all features on the devices being protected.

What is needed, therefore, is a device that can be used in conjunction with a personal electronic device such that one or more of the above-mentioned issues can be addressed. Heretofore these requirements have not been fully met without incurring various disadvantages.

One previous approach that has been proposed for protecting a computer tablet involves a foldable computer cover that includes a keyboard and a saw-toothed stop such that the device can be kept upright. A disadvantage of this previously-proposed approach is that this cover does not offer any mechanism to extend battery life. Further, this proposed approach also has the disadvantage of having no rear support to prevent the case from falling back.

### SUMMARY OF THE INVENTION

By way of summary, the present invention is a personal electronic device carrying case. A primary aspect of the invention is to provide an apparatus that offers any or all of several features that address one or more of the undesirable aspects associated with use of a personal electronic device, especially during travel.

In accordance with a first aspect of the invention, a personal electronic device carrying case is provided that serves to protect the personal electronic device and that includes a charging unit to extend the battery life of the personal electronic device and a physical keyboard. The charging unit may comprise a rechargeable battery and a charger. The charging unit and physical keyboard may be connected in a parallel circuit, such that both can simultaneously be coupled to the personal electronic device via an electrical connection such as a USB cable, a power cable, or a docking port. The charging unit preferably can provide reserve power to the personal electronic device when the device's internal battery is low. The charging unit can be charged, for example, via either an external charger or via power transfer from the personal electronic device when the personal electronic device is being charged, if the device supports this type of reverse charging.

In one embodiment, the carrying case includes three panels connected together and containing a securing mechanism such as a plurality of clips on an interior face of the first panel in order to secure the personal electronic device in place. An easel stand may be attached to, or formed with the outer face of the first panel. This stand allows the carrying case to sit generally upright, allowing a user to view the screen in a way similar to the way one would view a computer screen. A physical keyboard may be retained on the inner face of the third panel and may be attachable to the personal electronic device either wirelessly or via a connection cable, such as a USB cable, that allows the keyboard to be attached to the personal electronic device. This keyboard allows a user to use a physical keyboard and avoid virtual touch screen or miniature thumb operated keyboards.

In an alternative embodiment, the carrying case may include two pouches that are vertically adjacent or otherwise juxtaposed next to one another. The first pouch is of sufficient size to accommodate a personal electronic device such as a cell phone, and the second pouch is of sufficient size to accommodate a charging unit.

These and other features and aspects of the present invention will be better appreciated and understood when considered in conjunction with the following description and the accompanying drawings. It should he understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, and of the construction and operation of typical mechanisms provided with the present invention, will become more readily apparent by referring to the exemplary, and therefore non-limiting, embodiments illustrated in the drawings in which like reference numerals designate the same elements in the several views and in which:

FIG. 1 is a front elevation view of one embodiment of the inventive personal electronic device carrying case, showing the carrying case in a position in which it is in an open position and has an easel stand thereof retracted such that it is laying flat;

FIG. 2 is a side elevation view of the carrying case of FIG. 1, showing the carrying case in a position in which it is open and has the easel stand thereof deployed;

FIG. 3 is a side elevation view of the carrying case of FIGS. 1 and 2, showing the carrying case in a closed position;

FIG. 4 is a front elevation view of an alternative embodiment of the inventive carrying case; and

FIG. 5 is a front elevation view of another embodiment of the inventive personal electronic device carrying case, showing the carrying case in a position in which it is in an open position and has an easel stand thereof retracted such that it is laying flat.

### DESCRIPTION OF PREFERRED EMBODIMENTS

The present invention and the various features and advantageous details thereof are explained more fully with reference to the non-limiting embodiments described in detail in the following description.

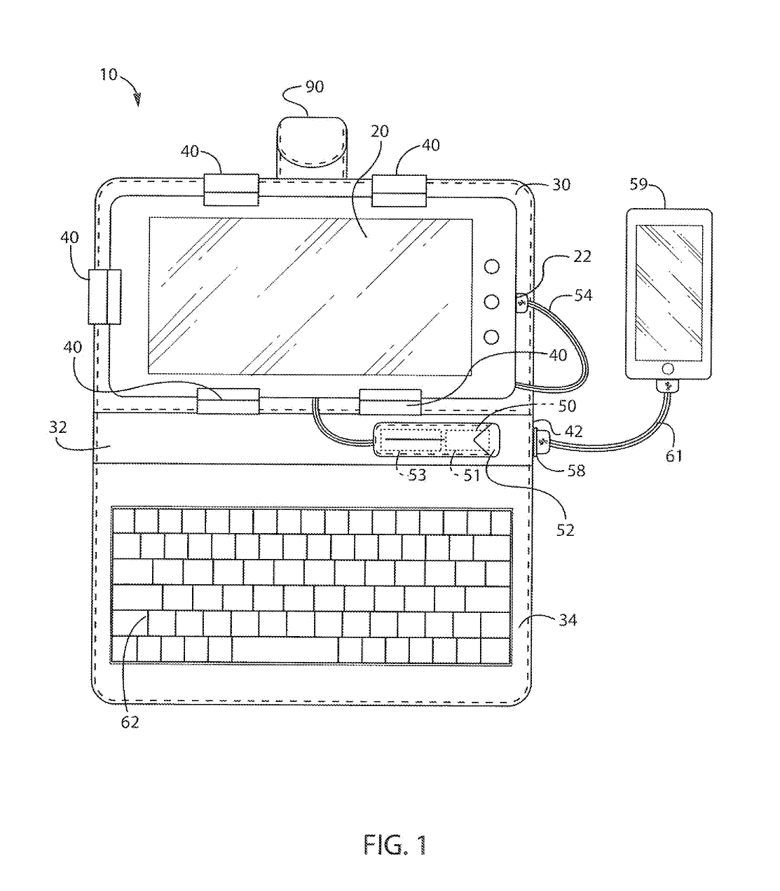

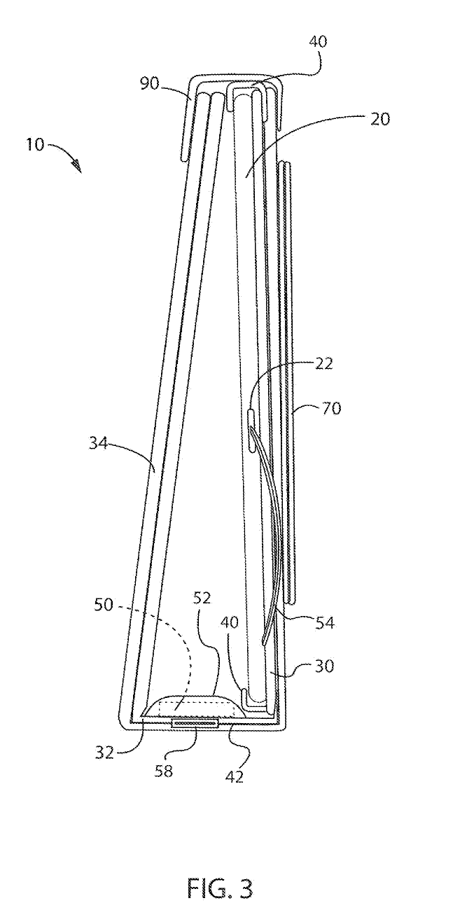

Referring first to FIGS. 1-3 and initially to FIG. 1, a personal electronic device protective carrying case 10 holds and protects a personal electronic device 20, while offering several features to enhance the experience of using the personal electronic device 20. The carrying case 10 of this embodiment is configured to hold a computer tablet. The carrying case 10 has a first panel 30, a second panel 32, and a third panel 34. The first panel 30 is connected to the second panel 32, and the second panel 32 is connected to the third panel 34. The first panel 30 and third panel 34 are of similar dimensions, while the second panel 32 is narrower. The second panel 32 can be considered a spine since it bridges a gap between the first panel 30 and the third panel 34 and extends generally perpendicularly to the first panel 30 and third panel 34 when the carrying case 10 is closed as shown in FIG. 3. In the illustrated embodiment, the first panel 30 and third panel 34 are about 5¼ inches (13½cms) by 9 inches (23 cms) and the second panel 32 is about 1¼ inches (3¾ cms) by 9 inches (23 cms). These dimensions are optimized for a generally rectangular computer tablet that is about 8″ wide by about 5″ high. Of course, different dimensions would be selected for other personal electronic devices of different sizes. Each panel may be made of a durable, rigid material such as plastic or cardboard and may be covered by a soft material such as cloth or leather.

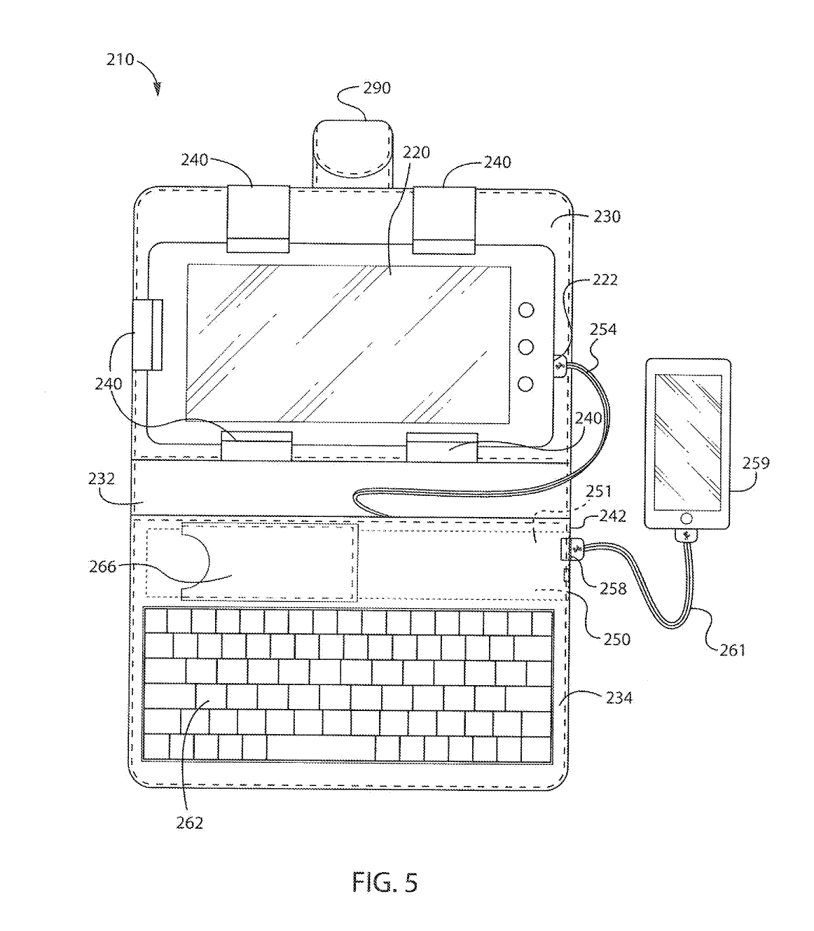

For example, as shown in FIG. 5, if a case 210 were configured for use with an Apple IPad® tablet, the dimensions of each of the first panel 230 and third panel 234 are about 9 inches (23 cms) by 11 inches (28 cms), and the second panel 232 is about 1¼ inches (3¼ cms) by 11 inches (28 cms). These dimensions are optimized for a generally rectangular computer tablet that is about 10″ wide by about 7″ high.

Still referring to FIG. 5, the charger unit 250 of case 210 may have an input port 258 on the outer edge 242 of the third panel 234, permitting another electrical device 259, such as an MP3 player or a cell phone, to be connected with a power cable 261. Power can thus be transferred from the battery 251 of the charger unit 250, to input port 258, and then to the interior battery of the other electrical device 259 via the power cable 261. Any of a number of adapters could be employed, if desired, to connect the power cable 261 to the device 259. The case 10 of FIGS. 1-4 could be provided with the same or similar input port. Case 210 of FIG. 5 otherwise could be at least conceptually identical to the case 10 of FIGS. 1-4.

It should be noted elements in FIG. 5 correspond to the same elements in FIG. 1-3, incremented by 200. A repeated description of these features has been abbreviated or omitted for conciseness.

Referring again to FIGS. 1-3, the inner face of the first panel 30 is provided with a securing mechanism for holding the personal electronic device in place. The securing mechanism could, for instance, comprise a pocket and/or clamps. In the illustrated embodiment, the securing mechanism comprises a plurality of clips 40 spaced around at least part of the periphery of the personal electronic device 20. These clips 40 may be made of a hard, inflexible material such as a rigid plastic or metal in order to keep the personal electronic device 20 in a stationary position. Five clips are provided in this embodiment. Specifically, two clips are provided above the personal electronic device, two clips are provide below the personal electronic device, and one to the side, in this case the left side, of the personal electronic device. More or less clips could be provided in other locations, if desired.

On the inner face of the second panel 32, there is a charging unit 50 held within a pouch 52. The pouch 52 may be formed in, sewn, or otherwise attached to the second panel 32. It may be opened to permit removal and replacement of the charger unit 50. The charger unit 50 preferably includes a battery 51 and a charger 53 coupled to each other in a manner permitting power transfer therebetween. The battery 51 may be a rechargeable battery such as a lithium battery. The charger unit 50 includes a USB or other cable connection 54 that permits the charger unit 50 to be coupled to the personal electronic device 20. Upon connecting the charger unit 50 to the personal electronic device 20, the charger unit 50 may be turned on using an on/off switch (not shown) to supply reserve power to the personal electronic device 20. Power thus is transferred from the battery 51 of the charger unit 50, to the charger 53, and then to the interior battery of the personal electrical device 20 via cable connection 54. This switch will help to guarantee that power is not wasted when the user does not desire it to be turned on. The primary mode of recharging the charger unit's battery will be by plugging the cable connection 54 into an external power source such as an AC adapter. In the alternative, the cable connection 54 may permit the battery of the charger unit to be charged via power draw from the personal electronic device 20, if the chanting unit 50 allows this type of charging.

The third panel 34 includes a physical keyboard 62. The physical keyboard 62 can be connected to the personal electronic device 20 either wirelessly or using a USB or other cable connection 54. In an especially preferred arrangement, the keyboard has the capability of both wireless communication via, e.g., a Bluetooth® interface, and a USB or other cable connection 54. It may be connected to both the device 20 and the charging unit 50 in a parallel connection. A parallel connection is preferred because it allows both the physical keyboard 62 and the charging unit 50 to be coupled to the personal electronic device 20 using the same USB or other cable connection 54. Such a coupling using the same USB or other cable connection 54 will be especially helpful in certain embodiments where a personal electronic device 20 features a single cable connection dock 22. Absent such a coupling, the user would not be able to use the charging unit 50 and the physical keyboard 62 simultaneously. The physical keyboard 62 allows the user to easily type messages and prepare other documents that may be difficult to complete in a timely manner using the virtual or miniature thumb operated keyboard of the personal electronic device 20. Additionally a physical USB or other cable connection 54 is dramatically less expensive in terms of material and licensing costs than a comparable wireless connection.

One or both of the first panel 30 and the third panel 34 may also include various pockets or pouches (not shown) for the storage of the user's belongings, such as business cards, credit cards, small notepads, or other personal objects. FIG. 5 shows an alternate embodiment with a pouch 266 for storage of business cards, credit cards, or other personal objects.

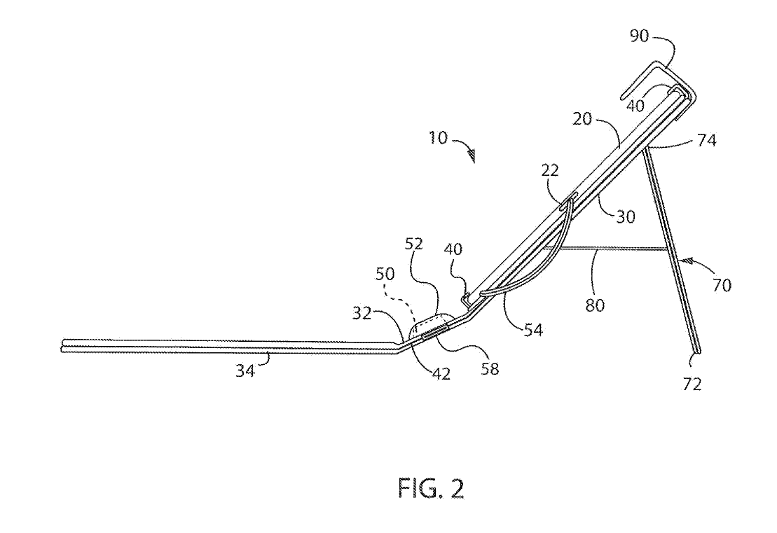

Referring now to FIG. 2, another feature of the personal electronic device carrying case 10 is an easel stand 70. The easel stand 70 has a lower end presenting a flat surface 72 that makes contact with the surface on which the carrying case 10 is supported when the easel stand 70 is deployed. An opposed, upper end 74 of the easel stand 70 is attached to the outer face of the first panel 30 via a memory hinge or other connection that permits the easel stand 70 to pivot relative to the first panel 30. The easel stand 70 preferably incorporates a measure to ensure that it is retained against the outer surface of the first panel 30 unless intentionally moved by the user. For example, a magnet may be provided on or in the easel stand 70 and may interact with a metal plate or magnet on or in the first panel 30 of the carrying case 10. Alternatively, mating hook and loop fasteners may be provided on the rear surface of the easel stand 70 and the outer surface of the first panel 30. The easel stand 70 is also attached to the outer face of the first panel 30 by a flexible membrane 80 such as a piece of cloth. The flexible membrane 80 has one end attached to the easel stand 70 between the upper end 74 and lower end 72 thereof and another end connected to the outer surface of the first panel 30. This flexible membrane 80 prevents the easel stand 70 from being over-extended such that the carrying case 10 will fall over. In one embodiment, the easel stand 70 is a length of about 4 inches.

It should be noted that mechanisms other than an easel stand 70 could be employed to selectively position the first panel 30 such that it is inclined relative to the third panel 34. For example, a stiff hinge, such as the ones used in laptop computer cases, could be positioned within the second panel 32 or between the first panel 30 and the second panel 32.

Also attached to the outer surface of the first panel 30 is a clasp 90 that permits the carrying case 10 to be securely closed as demonstrated in FIG. 3. This clasp 90 may be a long piece of flexible material with a magnet contained on or in the end thereof that mates with an additional magnet or metal plate on or in the outer surface of the third panel 34 when the carrying case 10 is closed thus holding the carrying case 10 closed. Other fasteners such as hook and loop fasteners or snaps could be used instead of or in addition to the magnetic fastener.

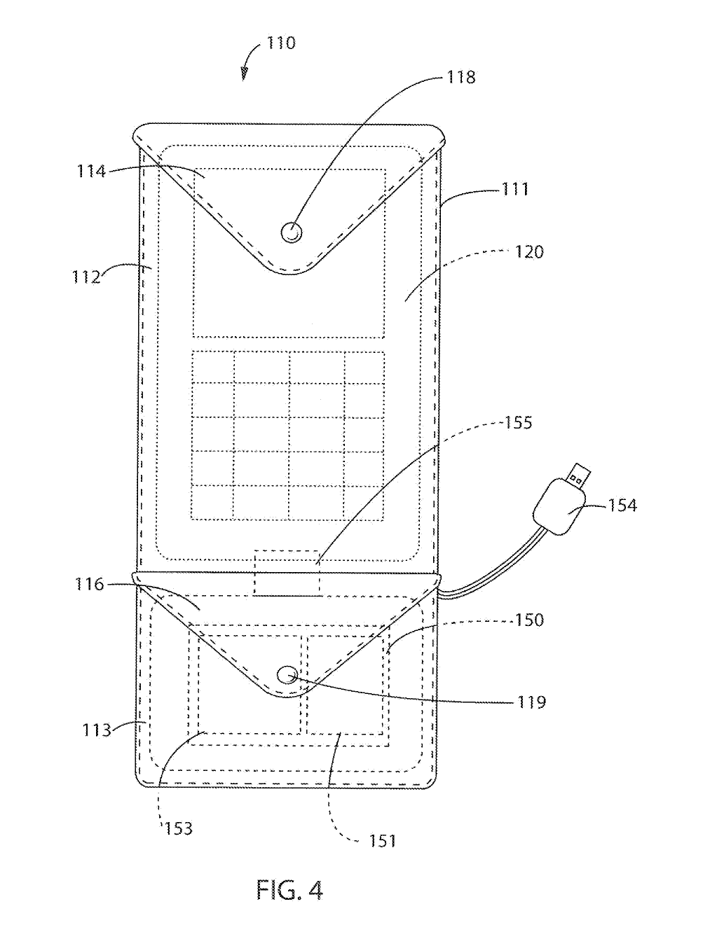

Referring now to FIG. 4, an alternative embodiment of the protective carrying ease 110 is illustrated that is well-suited for carrying a smart phone, PDA device, or other personal electronic device 120 that is smaller than the typical computer tablet. The carrying case 110 features a rigid or flexible back panel 111 with a first pouch 112 and a second pouch 113 positioned adjacent to one another. The first 112 and second 113 pouches overlay the back panel 111 and are located one above the other in the illustrated embodiment. The first pouch 112 can house the personal electronic device 120. The second pouch 113 can house a charging unit 150. As in the first embodiment, the charging unit 150 includes a rechargeable battery 151, a charger 153, and an electrical connection such as a docking port 155. Instead of or in addition to a docking port 155, a USB cable or similar cable 154 may be provided for connecting the charging unit 150 to an external power source and/or to the personal electronic device 120. Each of the pouches 111 and 113 has an upper flap 114, 116 respectively, that folds over the outer face of the body of the associated pouch and that can be fastened in place using a suitable fastener such as a snap 118, 119.

Although the best mode contemplated by the inventors of carrying out the present invention is disclosed above, practice of the present invention is not limited thereto. It will be manifest that various additions, modifications and rearrangements of the features of the present invention may be made without deviating from the spirit and scope of the underlying inventive concept.

What is claimed is:

1. A personal electronic device carrying case for a personal electronic device having an internal battery, the personal carrying case comprising:
a protective carrying case;
a securing mechanism for retaining the personal electronic device in place; and
a charging unit that includes a charger, a battery, and an electrical connection for selectively coupling the charging unit to the personal electronic device.

2. The personal electronic carrying case of claim 1, further comprising a pouch for holding the charging unit.

3. The personal electronic device carrying case of claim 1, wherein the securing mechanism for the personal electronic device comprises a plurality of clips attached to the interior face of the carrying case.

4. The personal electronic device carrying case of claim 1, wherein the securing mechanism for the personal electronic device composes a closable pouch.

5. The personal electronic device carrying case of claim 4, wherein the closable pouch and a second pouch for holding the charging unit are located vertically adjacent to one another.

6. The personal electronic device carrying ease of claim 1, wherein the protective carrying case is configured to support a physical keyboard located in the case.

7. The personal electronic device carrying case of claim 6, further comprising a first panel for supporting the personal electronic device, a second panel for supporting the physical keyboard, and a third panel that is located between the first and second panels and that supports the charging unit.

8. The personal electronic device carrying case of claim 7, wherein the third panel has a plurality of pouches.

9. The personal electronic device carrying case of claim 7, further comprising a clasp for retaining the carrying case in a closed position thereof.

10. The personal electronic device carrying case of claim 7, further comprising an easel stand which can be deployed to support the first panel in a position in which it is inclined relative to the second panel.

11. A personal electronic device carrying case for a personal electronic device having an internal battery and physical keyboard, the personal carrying case comprising:
a protective carrying ease;
a securing mechanism for retaining the personal electronic device in place;
a charging unit that includes a charger, a battery, and an electrical connection for selectively coupling the charging unit to the personal electronic device; and
a physical keyboard.

12. The personal electronic device carrying case of claim 11, wherein the charging unit and physical keyboard are connected in a parallel circuit.
